(19) United States
(12) Patent Application Publication
(10) Pub. No.: US 2007/0089234 A1
(43) Pub. Date: Apr. 26, 2007

(54) EMERGENCY EYEWASH STATION HAVING AN INTEGRATED HEAD REST

(75) Inventors: David J. Copeland, Milton, MA (US); Michael C. Pereira, Smithfield, RI (US)

Correspondence Address: BARLOW, JOSEPHS & HOLMES, LTD., 101 DYER STREET, 5TH FLOOR, PROVIDENCE, RI, 02903, US

(73) Assignee: FENDALL, INC., Plattville, WI (US)

(21) Appl. No.: 11/551,981

(22) Filed: Oct. 23, 2006

Related U.S. Application Data
(60) Provisional application No. 60/729,611, filed on Oct. 24, 2005.

(51) Int. Cl. A61H 33/00; A61H 33/04

(52) U.S. Cl. 4/620

(57) ABSTRACT

An emergency eyewash station is disclosed. The emergency eyewash station has a pivoting actuator arm that includes a headrest assembly to properly position a user's injured eyes the correct distance from the eyewash fluid dispensing eyepiece.

### CROSS-REFERENCE TO RELATED APPLICATION

This application claims priority to earlier filed U.S. Provisional Patent Application 60/729,611, filed Oct. 24, 2005, the contents of which are incorporated herein by reference.

### BACKGROUND OF THE INVENTION

1. Field of the Invention

The present invention is related to emergency eyewash stations and more particularly to an emergency eyewash station having an integrated headrest to facilitate proper orientation of the users head and eyes relative to the eyewash spray.

2. Background of the Related Art

Government and employers are increasingly aware of the need for protecting the health and safety of workers. For this reason, it is common to find emergency eye wash stations at industrial work sites, laboratories and other locations where workers are exposed to hazardous chemicals. The Occupational Safety and Health Administration (OSHA) has made eye wash station mandatory for particular industrial work sites.

Early installations of eye wash stations employed sprays of regular tap water fed from regular plant plumbing connections. These stations were typically located near a source of plumbed water, and the spray heads were retrofitted into existing sink structures. Later devices were self-contained, gravity fed, and independent of plumbing connections. These self-contained emergency eyewash stations generally include a reservoir for containing eyewash fluid and a dispensing structure to dispense the eyewash fluid therefrom. While each of the prior art installations sought to provide the requisite emergency eye wash spray function, they still lacked a standardized criteria for providing an adequate flow rate and/or flow rate for an adequate period of time.

In an effort to encourage more suitable eye wash facilities, the American National Standards Institute (ANSI) promulgated voluntary standards for portable eye wash fountains relating to flushing periods and the rate of flow of wash fluid. These standards dictate that portable eye wash fountains should deliver no less than 0.4 gallons per minute (1.5 liters per minute) of eye wash fluid for a time period of at least 15 minutes. Responsive to the new ANSI standards, several new designs emerged seeking to provide the required flow rates for the minimum periods of time. For the most part, the eye wash stations currently on the market do provide the required flow rates for the minimum period of time. However, these prior art eyewash stations suffer from the disadvantage in that they lack a means to align and position an injured person's head an optimal distance from the dispensing structure of the emergency eyewash station for optimal treatment of the injury.

This problem is in pressing need of a solution because it is difficult for an individual to properly align his or her head while partially or wholly blind, in severe pain, and with little or no assistance. Furthermore, assuming the affected individual has successfully activated the device and has begun the flushing process, the ANSI standards recommend that the individual maintain the eye flushing for a period of 15 minutes. While in the abstract this may not seem like a long period of time, it is noticeably uncomfortable to maintain the proper position of the head while bending at the waist over the device.

Therefore, there is a need for an emergency eyewash station that assists the injured individual to align his or her head properly and position his or her head at an optimal distance from the dispensing apparatus thereon.

Moreover, the faster an individual receives immediate proper treatment of the injury, the less likelihood the individual will suffer irreparable harm to his or her vision. Therefore, there is a need for an emergency eyewash station that speeds immediate and proper treatment of an eye injury caused by exposure to chemicals.

### SUMMARY OF THE INVENTION

The emergency eyewash station of the present invention addresses the problems of the prior art by providing a unique integrated headrest on the upper surface of the dispensing structure to align and position the individual's head an optimal distance from an eyepiece dispensing eyewash fluid therefrom. The headrest also partially supports the user and serves to reduce the fatigue and discomfort of trying to maintain the proper position for the required period of time.

Accordingly, among the object of the present invention is the provision for an emergency eyewash station that includes an integrated headrest support for a user.

Another object of the present invention is the provision for an emergency eyewash station that includes a pivoting actuator arm assembly that includes an integrated headrest support.

Yet, another object of the present invention is the provision for an emergency eyewash station that has a substantially flush exterior body when the station is not in use.

### BRIEF DESCRIPTION OF THE DRAWINGS

These and other features, aspects, and advantages of the present invention will become better understood with reference to the following description, appended claims, and accompanying drawings where:

FIG. 1 is a perspective view of a preferred embodiment of the present invention showing an emergency eyewash station including a dispensing structure;

FIG. 2 is a perspective view of the emergency eyewash station shown in FIG. 1, which shows the actuator arm assembly in the armed position;

FIG. 3 is a conceptual view of the headrest integrated into the dispensing structure; and

FIG. 4 is side view of the preferred embodiment of the present invention illustrating use thereof.

### DESCRIPTION OF THE PREFERRED EMBODIMENT

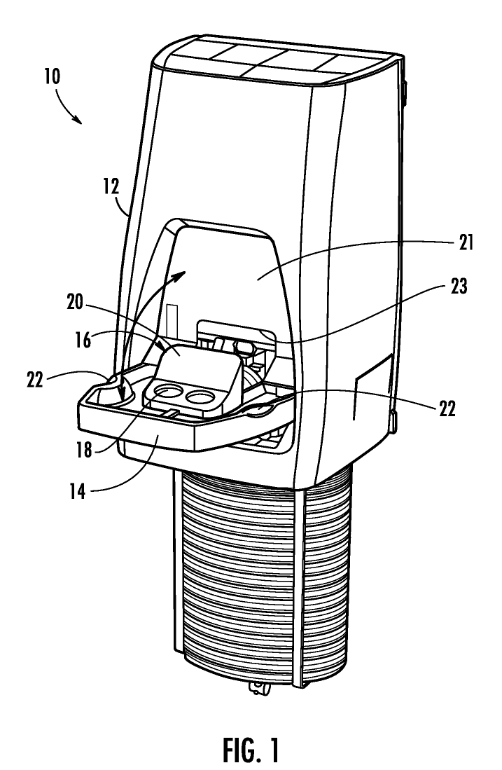

Referring to FIG. 1, the preferred embodiment of the emergency eyewash station of the present invention is shown generally at 10. As will hereinafter be more fully described, the emergency eyewash station 10 of the present invention includes a main body portion 12, which dispenses an eyewash fluid from an internal reservoir (not shown) upon activation of an actuator arm assembly 14.

In particular, the actuator arm assembly 14 has a dispensing structure 16 thereon. The dispensing structure 16 has an eyepiece 18 that is in fluid connection with the internal reservoir. Situated adjacent to the eyepiece 18, is a headrest portion 20. The headrest portion 20 has a contoured surface to distribute the weight and pressure of the user's head and improve the overall comfort to of the user. On either side of the actuator arm assembly are optional handholds 22. The body portion 12 has a first recessed area 21, which is configured to receive the actuator arm assembly 14 when in the closed or armed position. A second recessed area 23, further inset from the second recessed area 21, is configured to receive the headrest portion 20.

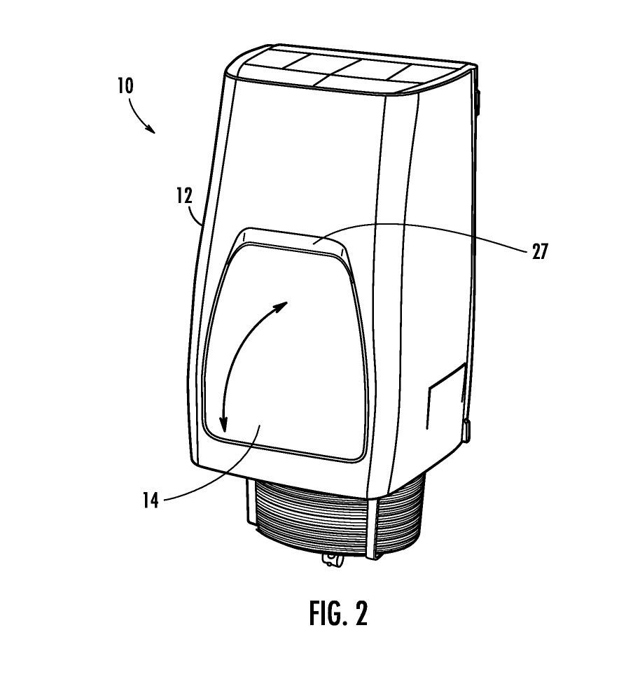

Referring to FIG. 2 the emergency eyewash station 10 of the present invention is shown with the actuator arm assembly 14 in the closed or armed position. Because the body portion 12 is configured with the recessed areas 21, 22, the actuator arm assembly 14 closes flush with the outer surface of the body 12 to present a clean uniform appearance to the emergency eyewash station 10, which is aesthetically desirable. A small gap 27 is left at the top of the actuator arm assembly 14 between the body portion 12, which serves a handhold the user can grip and pull, thereby activating the emergency eyewash station 10.

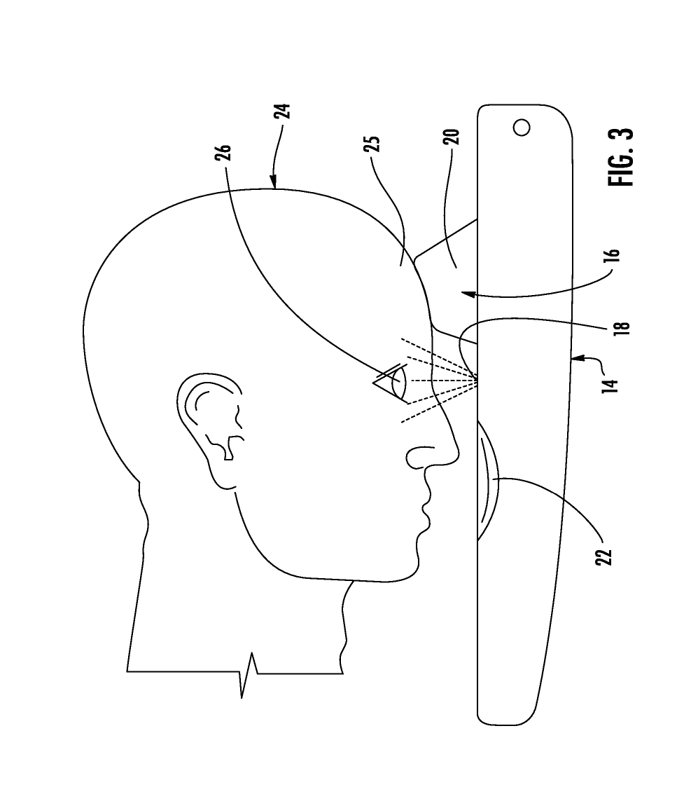

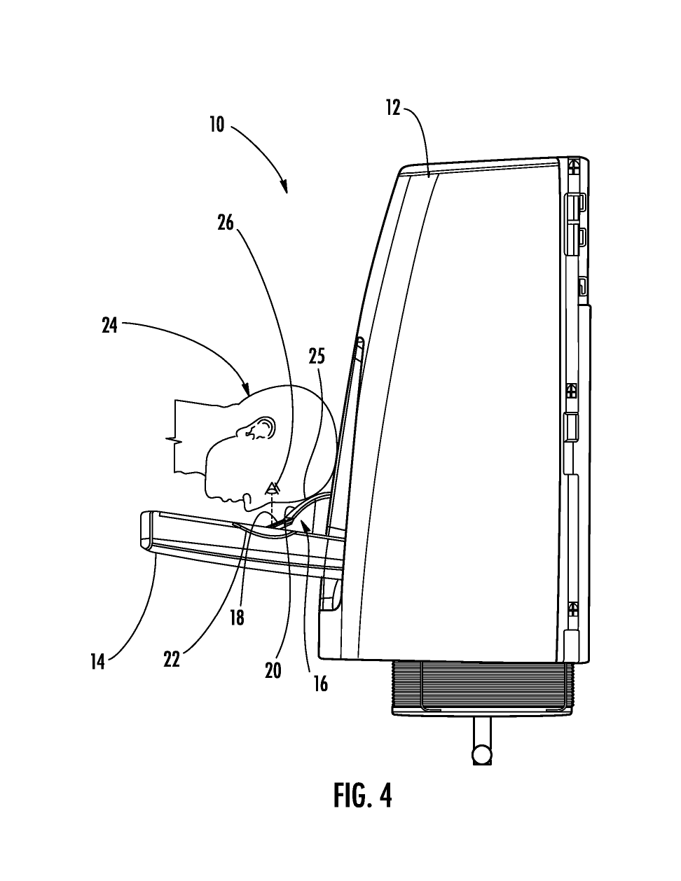

Referring to FIGS. 3 and 4, an injured individual 24 begins treatment by activating the actuator arm assembly 14 to start the flow of eyewash fluid out of the eyepiece 18 of the dispensing structure 16. The individual 24 then places his or her forehead 25 on the headrest portion 20 of the dispensing structure 16 and looks with his or her eyes 26 into the eyepiece 18. The position of the headrest 20 proximal to the eyepiece 18 naturally aligns the individual's eyes 26 over the eyepiece 18 and at an optimal distance from the eyepiece 18 according to the pressure of the eyewash fluid being dispensed therefrom such that the injured area is gently and thoroughly bathed in eyewash fluid.

The headrest 20 and optional handholds 22 function to at least partially support the user 24 during operation, and seek to reduce the fatigue and disorientation that can occurs during treatment, and while attempting to maintain the head in the proper position for optimal treatment. The handholds 22 are particularly important in maintain balance while bending over.

Therefore, it can be seen that the present invention provides a unique solution to the problems of the prior art by providing an emergency eyewash station with an integrated headrest that naturally aligns the injured persons eyes for optimal treatment of the injury.

It would be appreciated by those skilled in the art that various changes and modifications can be made to the illustrated embodiments without departing from the spirit of the present invention. All such modifications and changes are intended to be within the scope of the present invention except as limited by the appended claims.

What is claimed is:

1. An emergency eyewash station, comprising:
a body portion;
an actuator arm assembly having an inner surface and an outer surface and connected to said body portion and movable between an armed position and an activated position;
a dispensing structure extending from said inner surface of said actuator arm assembly including a dispensing eyepiece and a headrest portion;
said headrest portion positioned relative to said dispensing eyepiece to optimally position a user's eyes over said dispensing eyepiece; and
a reservoir located within said body portion and configured and arranged to dispense eyewash fluid out of said dispensing eyepiece when said actuator arm assembly is moved to the activated position.

2. The emergency eyewash station of claim 1, wherein said actuator arm assembly is pivotal between said armed position and said activated position.

3. The emergency eyewash station of claim 1, wherein said outer surface of said actuator arm assembly and said body portion are configured and arranged to present a substantially uniform outer surface when said actuator arm assembly is in said armed position.

4. The emergency eyewash station of claim 1, further comprising:
a first recess formed on body portion and configured and arranged to receive the actuator arm assembly when in the armed position;
a second recess formed within said first recess and configured and arranged to receive said dispensing structure when said actuator arm assembly is in the armed position; and
said outer surface of said actuator arm assembly substantially conforming to said body portion.

5. The emergency eyewash station of claim 4, wherein when said actuator arm assembly is in the armed position said actuator assembly and said body portion define a gap that forms a handle to activate said emergency eyewash station.

6. The emergency eyewash station of claim 1, further comprising:
a pair of handholds formed on either side of said actuator arm assembly.

7. The emergency eyewash station of claim 1, wherein said headrest portion includes a contoured surface to improve the comfort of the user.
